(19) United States
(12) Patent Application Publication
(10) Pub. No.: US 2013/0104373 A1
(43) Pub. Date: May 2, 2013

(54) Pole Hanger

(71) Applicant: HOPKINS MANUFACTURING CORPORATION, Emporia, KS (US)

(72) Inventor: Pieter Schouten, Berkeley, CA (US)

(73) Assignee: HOPKINS MANUFACTURING CORPORATION, Emporia, KS (US)

(21) Appl. No.: 13/663,059

(22) Filed: Oct. 29, 2012

Related U.S. Application Data
(60) Provisional application No. 61/552,958, filed on Oct. 28, 2011.

(51) Int. Cl. F16M 13/02; B23P 11/00

(52) U.S. Cl. 29/456; 248/534

(57) ABSTRACT

A hanger tool that includes an elongated body with an upper portion and a lower portion, a first opening formed in the upper portion of the elongated body, an attachment body connected to the lower portion of the elongated body, a second opening formed in the attachment body, a teeth protruding into the opening. The elongated body and the second opening are oriented at approximately 90 degrees relative to each other. The second opening is sized to frictionally engage an implement in order to securely hold the implement in place, and to lock the hanger tool in place between the head and pole portions of the implement when these portions are connected together.

### PRIORITY CLAIM

The present application claims priority to U.S. Provisional Application Ser. No. 61/552,958, filed Oct. 28, 2011, the entirety of which is hereby incorporated by reference.

### BACKGROUND OF THE INVENTION

1. Field of the Invention

The present invention relates to a hanger tool and, more specifically, to a tool for hanging a variety of poles for retail display or storage.

2. Description of the Related Art

Implements with a head and a handle, including mops, brooms, and squeegees, for example, are often hung on racks when they are displayed for sale or storage. Often the rack consists of two parallel protruding rods with the pole portion of the implement sliding between the rods and the head portion of the implement resting on the rods. The rack may also consist of a series of peg hooks onto which the implement hangs. However, safety can be issue with these display methods as the implements frequently fall off the rack, thereby damaging the implement, nearby merchandise, or even people.

It is therefore a principal object and advantage of the present invention to provide a pole hanger tool for hanging poles in a retail or storage setting with increased safety.

It is another object and advantage of the present invention to provide a pole hanger using a trapped assembly, whereby the pole hanger is reversibly trapped between the head and the pole of the implement.

It is yet another object and advantage of the present invention to provide a pole hanger

Other objects and advantages of the present invention will in part be obvious, and in part appear hereinafter.

### BRIEF SUMMARY OF THE INVENTION

In accordance with the foregoing objects and advantages, the present invention provides a hanger tool, comprising an elongated body comprising an upper portion and a lower portion, a first opening formed in said upper portion of said elongated body, an attachment body connected to the lower portion of said elongated body, a second opening formed in said attachment body, wherein said elongated body and said second opening are at approximately 90 degrees relative to each other; and a plurality of teeth protruding into a plane of the opening. The opening is sized to frictionally engage an implement in order to securely hold the implement in place, and to lock the hanger tool in place between the head and pole portions of the implement when these portions are connected together. The opening further comprises one or more teeth for engaging the implement. The upper portion of the elongated body of the tool can comprise an opening, hook, latch, or other means for attaching the tool to a display or storage surface.

In use, the user slides the large lower opening of the hanger tool over the implement handle or pole, and then connects the handle/pole to the head of the implement. If the hanger tool is to be locked in place between the handle and the head, the sections are connected with the hanger tool located between them. Alternatively, the hanger tool can be held in place only by the implement head, which cannot fit through the opening.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a perspective view of an aspect of the invention according to one embodiment;

FIG. 2 is a side view of an aspect of the invention according to one embodiment;

FIG. 3 is a top view of an aspect of the invention according to one embodiment;

FIG. 4 is a bottom view of an aspect of the invention according to one embodiment;

FIG. 5 is an exploded view of an aspect of the invention according to one embodiment; and

FIG. 6 is a side view of an aspect of the invention according to one embodiment.

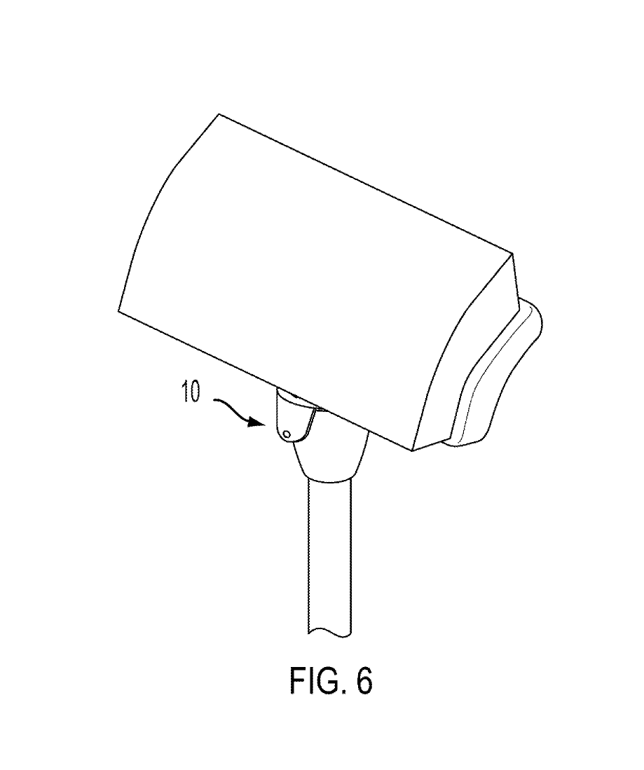

### DETAILED DESCRIPTION OF THE INVENTION

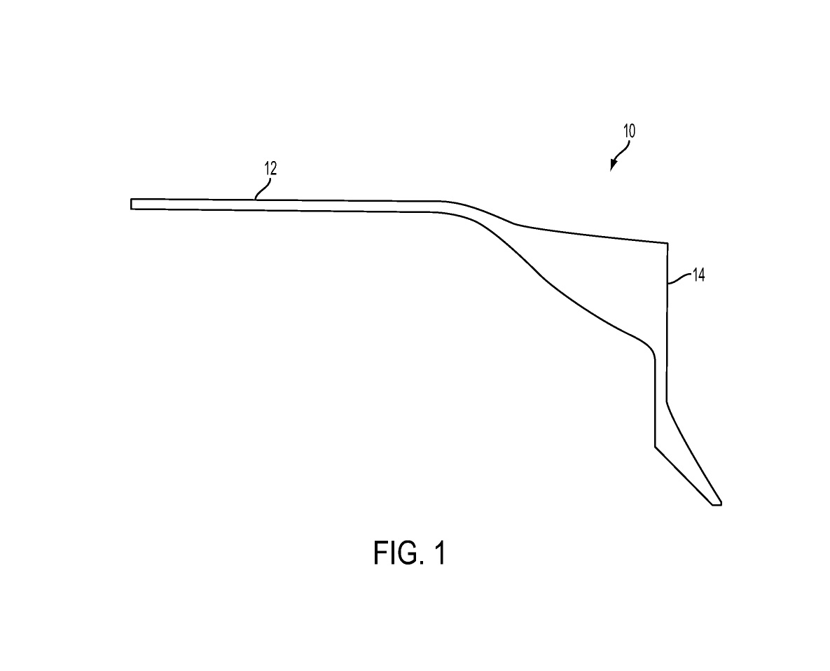

Referring now to the drawings, wherein like reference numerals refer to like parts throughout, there is seen in FIG. 1 an elongated hanger tool designated generally by reference numeral 10, comprising an elongated hanging portion 12 and an attachment portion 14.

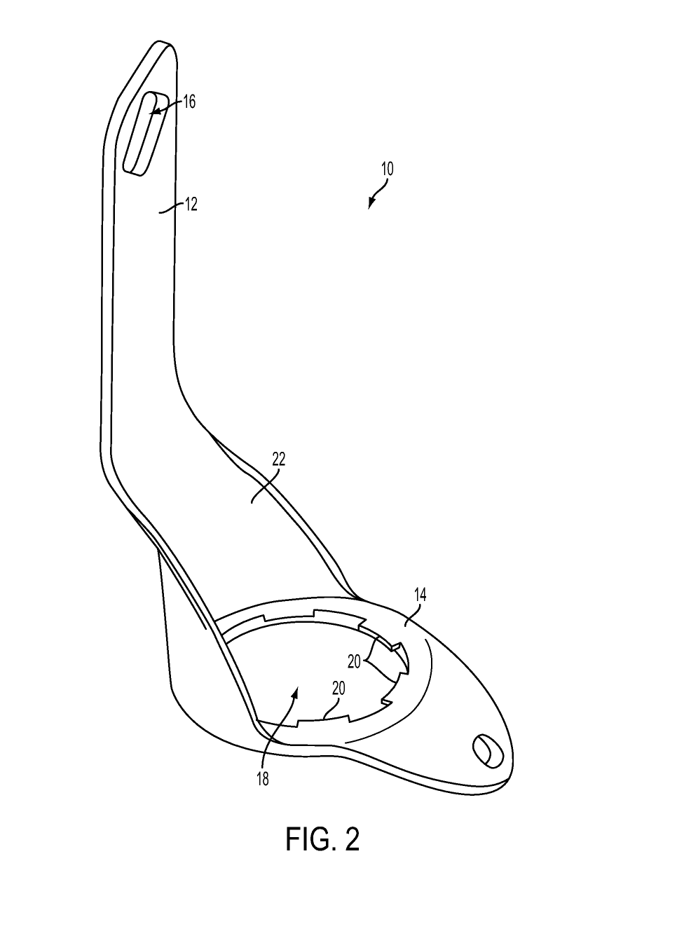

Referring to FIG. 2, elongated hanging portion 12 of tool 10 is roughly rectangular, although other shapes are possible, and preferably comprises a hole, loop, hook, or other attachment means or mechanism, denoted generally by reference numeral 16, for attaching tool 10 to a display or storage surface. Hanging portion 12 may also comprise a rounded or curved shape to complement the implement, or can otherwise be shaped to complement the portion of the implement that is in proximity to this section of the tool. For example elongated hanging portion 12 can comprise an opening for a portion of an implement that protrudes or would otherwise interfere with the hanger tool, or which should be displayed to the user. Elongated hanging portion 10 can comprise any desired length. Longer lengths, for example, can accommodate larger tools such as large brush heads or mops, while shorter lengths can accommodate smaller tools such as small brush heads.

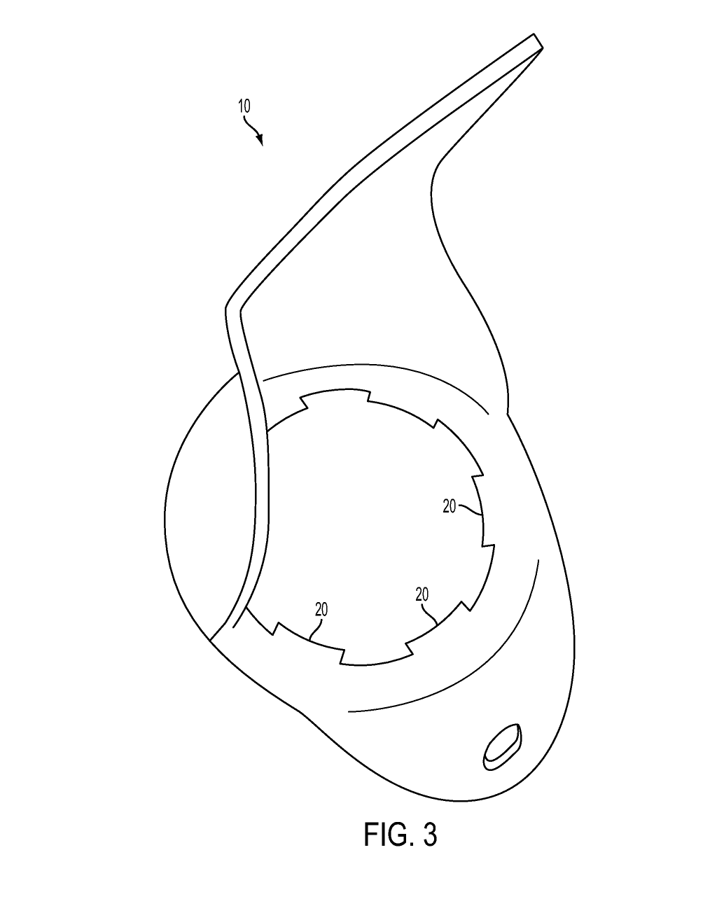

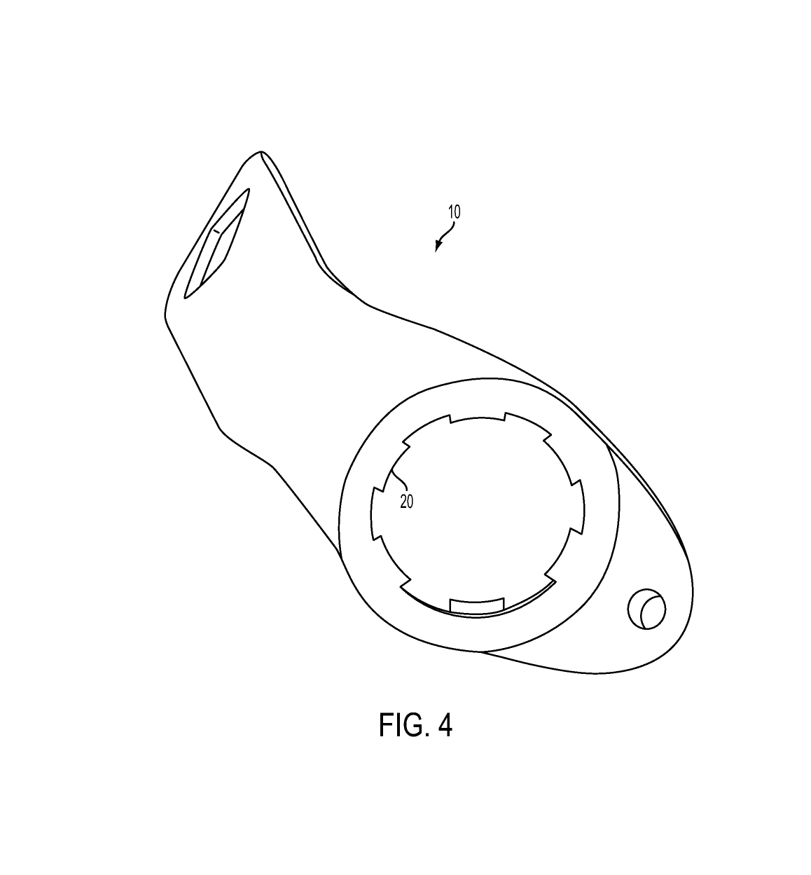

Attachment portion 14 of tool 10 comprises an opening 18 for an implement, as shown in FIGS. 2-5. Opening 18 can be sized to fit a wide variety of implements, and can either be completely closed (shown in FIG. 2, for example) or partially open (not shown). In addition to pre-sizing opening 18, the opening can comprise one or more flexible teeth 20 (it being understood that the term “teeth” includes other protrusions, such as ribs, flanges, castellations and the like), which both help to create a snug fit of the implement within the opening, and also facilitate locking the implement in place. In a preferred embodiment, hanging portion 12 is attached to attachment portion 14 at the periphery of opening 18.

An implement such as a broom can be reversibly attached to tool 10 via several mechanisms, including but not limited to the following: (i) opening 18 of the tool is slid over the handle of the implement; (ii) the handle of the implement and the head of the implement are connected to each other. In a preferred embodiment, tool 10 is trapped between the handle and the head of the implement. Teeth 20 of the tool help lock the tool in place in this embodiment as they are trapped when the head and handle of the implement are connected together. To remove hanging tool 10, the customer or user separates the head and handle of the implement, thereby freeing the tool. In another embodiment, tool 10 is held in place only by the implement head, where the implement head is too large for opening 18. In this embodiment, teeth 20 inhibit excess movement of the tool along the pole of the implement.

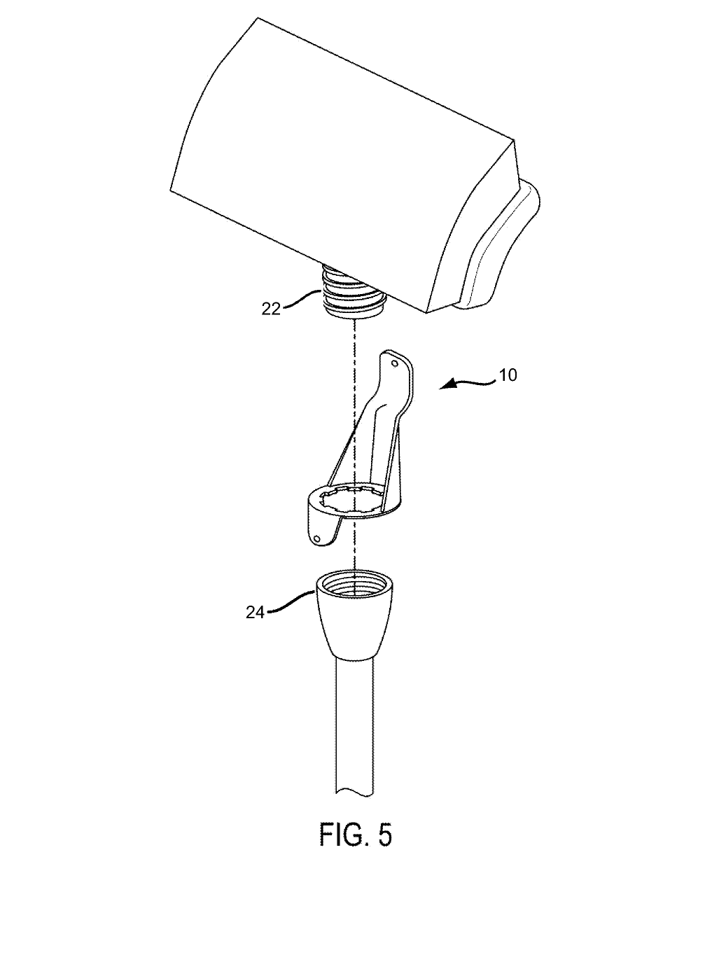

In another embodiment, depicted in FIG. 5, an implement such as a broom can be reversibly attached to tool 10 via the following mechanism: (i) threads 22 of the implement are inserted through opening 18 of the tool; and (ii) threads 22 of the implement are screwed into locking nut 24 to connect the handle of the implement and the head of the implement together. In a preferred embodiment, tool 10 is trapped between the handle and the head of the implement. Teeth 20 of the tool help lock the tool in place in this embodiment as they are trapped when the head and handle of the implement are connected together. To remove hanging tool 10, the customer or user separates the head and handle of the implement, thereby freeing the tool.

Although the present invention has been described in connection with a preferred embodiment, it should be understood that modifications, alterations, and additions can be made to the invention without departing from the scope of the invention as defined by the claims.

What is claimed is:

1) A hanger for a pole and cleaning implement, comprising:
a) an elongated body comprising an upper portion and a lower portion;
b) an attachment body connected to and extending essentially perpendicularly outwardly from the lower portion of said elongated body;
c) a first opening formed in said attachment body, wherein said elongated body and said first opening are oriented at approximately 90 degrees relative to each other; and
d) a plurality of teeth protruding into a plane of the second opening.

2) The hanger according to claim 1, further comprising a second hole formed through said upper portion of said elongated body.

3) A method for hanging a pole and cleaning implement that comprises a pole and a threaded stub for connecting to the cleaning head, comprising the steps of:
a) providing a hanger having:
i) an elongated body comprising an upper portion and a lower portion;
ii) an attachment body connected to and extending essentially perpendicularly outwardly from the lower portion of said elongated body;
iii) a first opening formed in said attachment body, wherein said elongated body and said first opening are oriented at approximately 90 degrees relative to each other; and
iv) a plurality of teeth protruding into a plane of the first opening;
b) inserting the threaded stub of the cleaning implement through said first opening;
c) attaching the cleaning head to the threaded stub; and
d) hanging said hanger.

4) A method for hanging a cleaning implement, the cleaning implement comprising: (i) a pole comprising a locking nut and (ii) a cleaning head comprising a threaded stub, comprising the steps of:
a) providing a hanger having:
i) an elongated body comprising an upper portion and a lower portion;
ii) an attachment body connected to and extending essentially perpendicularly outwardly from the lower portion of said elongated body;
iii) a first opening formed in said attachment body, wherein said elongated body and said first opening are oriented at approximately 90 degrees relative to each other; and
iv) a plurality of teeth protruding into a plane of the second opening.
b) inserting the threaded stub of the cleaning head through the top of said first opening;
c) inserting the threaded stub of the cleaning head into the locking nut at a position below said first opening;
d) tightening the locking nut on the threaded end at a position below said first opening; and
e) hanging said hanger.
